(19) United States
(12) Patent Application Publication
(10) Pub. No.: US 2015/0152956 A1
(43) Pub. Date: Jun. 4, 2015

(54) DISCONNECTABLE PULLEY DEVICE, ALTERNATOR COMPRISING SUCH A DEVICE AND INTERNAL COMBUSTION ENGINE EQUIPPED WITH SUCH A DEVICE OR SUCH AN ALTERNATOR

(71) Applicants: Ludovic FENAYON, Montbazon (FR); Alain GEZAULT, Vineuil (FR); Torbjorn HEDMAN, St Cyr sur Loire (FR)

(72) Inventors: Ludovic FENAYON, Montbazon (FR); Alain GEZAULT, Vineuil (FR); Torbjorn HEDMAN, St Cyr sur Loire (FR)

(73) Assignee: AKTIEBOLAGET SKF, Goteborg (SE)

(21) Appl. No.: 14/557,505

(22) Filed: Dec. 2, 2014

(30) Foreign Application Priority Data
Dec. 2, 2013 (FR) FR1361938

(51) Int. Cl. F16H 57/04; F02B 67/06; F16D 41/07; F16H 55/36

(52) U.S. Cl. CPC F16H 57/0489; F16H 55/36; F02B 67/06; F16D 41/07; F16D 2300/06

(57) ABSTRACT

This disconnectable pulley device comprises a central member, a pulley mounted around the central member, a free wheel itself comprising several cams mounted between a first slippage path, made on an external radial surface of the central member or of an element secured to this member, and a second slippage path made on an internal radial surface of the pulley or of an element secured to the pulley, the free wheel ensuring a unidirectional clutch between the pulley and the central member. At least one slippage path, from among the first and second slippage path, and/or a portion of the cams intended to interact with one of the slippage paths comprises a tungsten disulfide layer.

### CROSS REFERENCE TO RELATED APPLICATION

This is a National Stage application claiming the benefit of French Patent Application Number FR1361938 filed on 2 Dec. 2013, which is incorporated herein by reference in its entirety.

### TECHNICAL FIELD OF THE INVENTION

The present invention relates to a disconnectable pulley device. More specifically, the present invention falls within the field of disconnectable pulleys equipped with a free wheel and used, for example, for driving an alternator inside an internal combustion engine of an automobile vehicle.

### PRIOR ART

Such a disconnectable pulley is used, in a known way, for finding a remedy to detrimental effects of acyclisms or sudden decelerations of the engine which occur in internal combustion engines, in particular at low speed for diesel engines. Indeed a driving pulley which is connected to the engine via a crankshaft pulley may suddenly decelerate, while a driven pulley, for example a drive pulley of an alternator, inertially tends to continue to rotate at the same speed. In the case of rigid coupling between the crankshaft pulley and the shaft of the alternator, the belt is subject to substantial stresses during such variations of instantaneous speed. These speed variations generate abnormal fatigue of the belt, with risks of breaking, as well as slipping of the latter on the pulleys or vibrations of its tensioned strands between the pulleys. It is therefore known how to benefit from the advantage of a free wheel system within a pulley device, such a device comprising cams which may engage with two slippage paths respectively made on a central member and on the pulley or an element secured to the latter. With this type of equipment, lubrication between the cams and the slippage paths, most particularly the slippage path made on the central member, may be faulty since a lubricant, like grease which is normally deposited on this slippage path, tends to be centrifuged, to the point that the contact between the cams and the slippage path may occur <<under dry conditions>>.

For dealing with this problem, providing the slippage path of the inner element of a disconnectable pulley device with a coating which has, under a load of 0.05 kg, a Vickers hardness comprised between 1,500 and 3,000 Hv, as well as a thickness comprised between 1 and 5 micrometers (μm) is known from FR-A-2 933 460. Such a solution globally gives satisfaction and the material of the coating applied on the slippage path is, in practice, an amorphous carbon layer related to diamond, known under the designation of DLC (<<Diamond Like Carbon>>). Such a material is relatively difficult to elaborate, therefore expensive, which in practice limits its use in disconnectable pulley devices which should have a price cost as low as possible.

These are the problems which the invention more particularly intends to remedy by proposing a disconnectable pulley device which is efficient for avoiding premature wear of its cams, while having an attractive price cost.

### SUMMARY OF THE INVENTION

For this purpose, the invention relates to a disconnectable pulley device comprising a central member, a pulley mounted around the central member, as well as a free wheel itself comprising itself several cams mounted between a first slippage path, made on an external radial surface of the central member or of an element secured to this member, and a second slippage path, made on an internal radial surface of the pulley or of an element secured to the pulley, the free wheel ensuring a unidirectional clutch between the pulley and the central member. According to the invention, at least one slippage path, from among the first and second slippage paths of the free wheel, and/or a portion of the cams intended to interact with either one of the first and second slippage paths of the free wheel comprises a layer of tungsten disulfide (WS₂).

By the use of tungsten disulfide at the first slippage path, in the case of disappearance of the film of the lubricant between the cams of the free wheel and this slippage path, the tungsten disulfide layer ensures lubrication between the cams and the slippage path. A direct metal contact between the cams and the central member is thus avoided, which increases the lifetime of the cams and of their slippage paths and prevents pollution of the surroundings in which is mounted the device of the invention, since it is very unlikely that metal particles or shavings be generated at the interface between the cams and the first slippage path.

According to advantageous but not mandatory aspects of the invention, such a disconnectable pulley device may incorporate one or more of the following features, taken in a technically acceptable combination:

The first slippage path comprises a tungsten disulfide layer.

The second slippage path comprises a tungsten disulfide layer.

Portions of the cams intended to interact with either one of the slippage paths are coated with a tungsten disulfide layer.

Each tungsten disulfide layer has a radial thickness comprised between a 0.5 μm and 0.8 μm (micrometers).

The tungsten disulfide is in a crystalline form, with crystals for which the crystalline diameter is comprised between 0.8 and 1.5 μm and for which the thickness is less than or equal to 100 nm (nanometers).

The free wheel comprises a lubricant positioned between the first slippage path and the second slippage path so as to impregnate each tungsten disulfide layer, notably with grease based on soap of the polyurea or diurea type and on oil of the synthetic hydrocarbon mineral or ester type.

Alternatively, each tungsten disulfide layer fulfills an anti-slippage function without adding any lubricant.

The invention also relates to an alternator which comprises a disconnectable pulley device as mentioned above.

Finally, the invention relates to an internal combustion engine provided with a disconnectable pulley or with an alternator as mentioned above.

### BRIEF DESCRIPTION OF THE DRAWINGS

The invention will be better understood and other advantages thereof will become more clearly apparent in the light of the description which follows of an embodiment of a disconnectable pulley device, of an alternator and of an engine compliant with its principle, only given as an example and made with reference to the appended figures, wherein:

FIG. 1 is an axial sectional view of a disconnectable pulley device according to the invention,

FIG. 2 is a partial sectional view along the line II-II in FIG. 1 and

FIG. 3 is an illustration of the microscopic structure of a tungsten disulfide layer used in the device of FIGS. 1 and 2.

### DETAILED DESCRIPTION OF THE PRESENT INVENTION

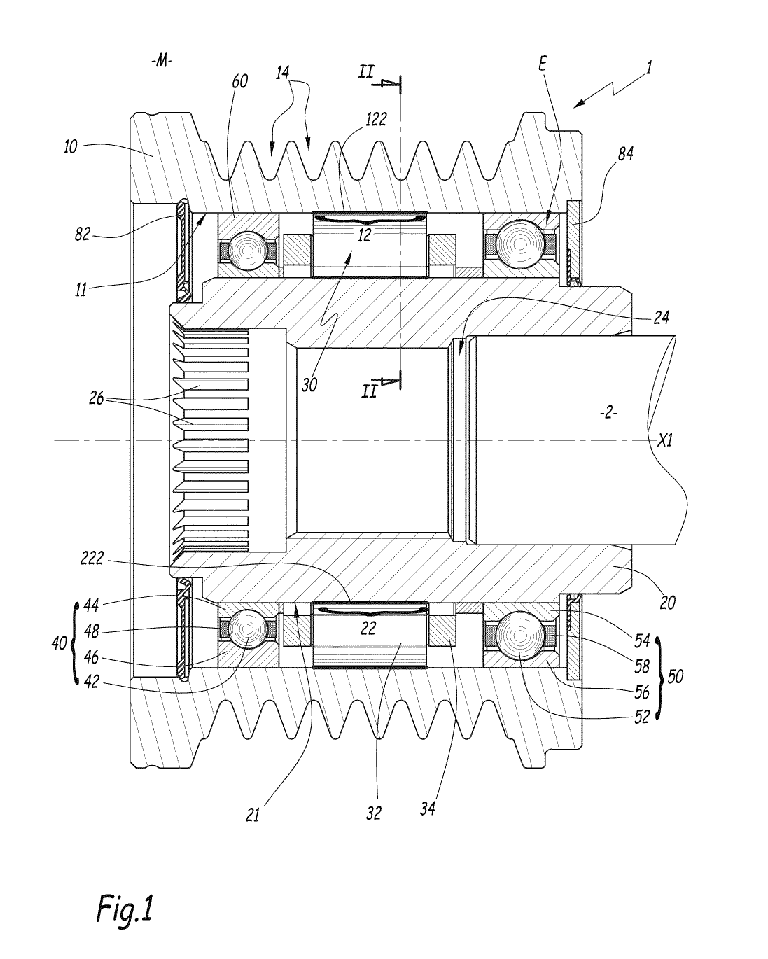

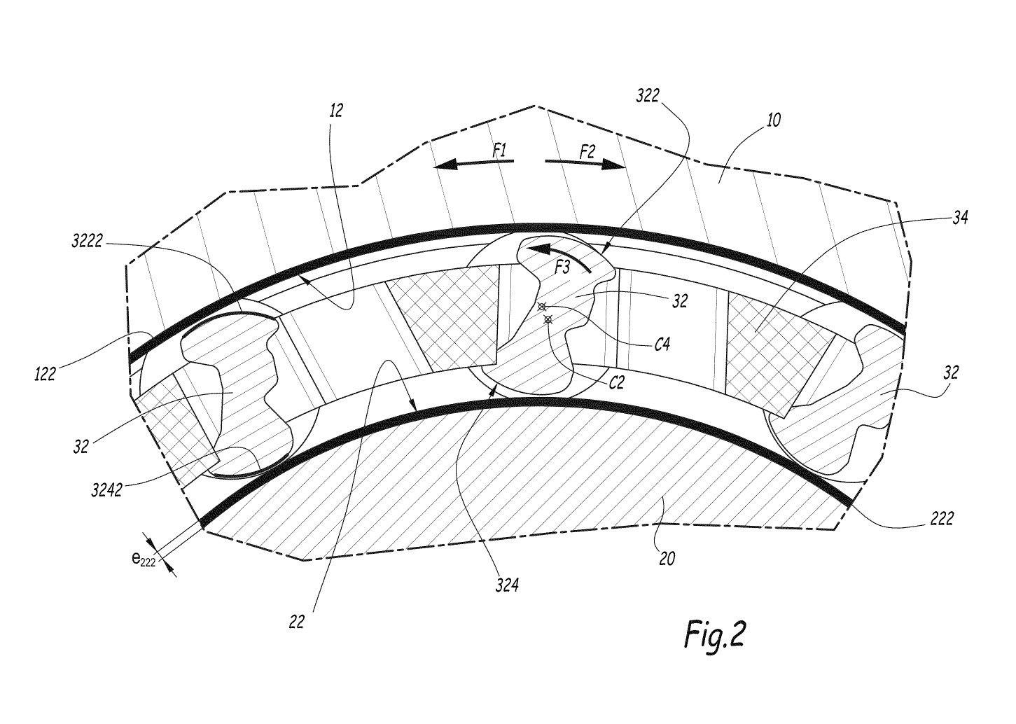

In FIGS. 1 and 2 is illustrated a disconnectable pulley device 1 according to the invention. This device is adapted for fitting out a motor vehicle alternator partly illustrated with its shaft 2 in FIG. 1. The elements 1 and 2 are part of the internal combustion engine M of a motor vehicle.

The device 1 is centered on an axis X1 relatively to which are defined the adjectives <<axial>> and <<radial>>. A direction is axial if it is parallel to the axis X1 and radial if it is perpendicular and secant to the axis X1. A surface is axial if it is perpendicular to an axial direction and is radial if it is perpendicular to a radial direction.

The device 1 comprises an external pulley 10, a central hub 20 and a free wheel 30 which forms a unidirectional clutch device. Two bearings 40 and 50 are positioned on either side of the free wheel 30, along the axis X1. The free wheel 30 and the bearings 40 and 50 are positioned inside an annular space E radially defined between an internal radial surface 11 of the pulley 10 and an external radial surface 21 of the hub 20, the elements 10 and 20 being movable in rotation relatively to each other around the axis X1, by means of bearings 40 and 50.

The bearings 40 and 50 are identical. The bearing 40 comprises a series of balls 42 positioned between an internal ring 44 and an external ring 46 and held in position by means of a cage 48. Also, the bearing 50 comprises balls 52, an internal ring 54, an external ring 56 and a cage 58. Alternatively, other bearings with rolling bodies may be used instead of the bearings 40 and 50, for example roller bearings.

The pulley 10 is equipped with external grooves 14 conformed in order to partly receive a torque transmission belt, not shown, while the hub 20 defines an internal bore 24 conformed for receiving the shaft 2 and having splines 26 facilitating transmission of a torque.

The device 1 also comprises two gaskets 82 and 84 attached on the external pulley 10 and each provided with a bearing lip sliding against the surface 21 of the hub 20.

The free wheel 30 as for it, comprises jamming cams 32 held into place between the elements 10 and 20 by a cage 34. The cams 32 are respectively positioned facing a central area 22 of the surface 21 defined between the rings 44 and 54 and which forms a first internal slippage path for these cams. Also, the cams 32 are positioned facing a central area 12 of the surface 11, defined between the rings 46 and 56 and which forms a second external slippage path for the cams 32.

The slippage paths 12 and 22 are cylindrical, with a circular section, and centered on the axis X1.

The geometry of a cam 32 more particularly emerges from FIG. 2. Each cam 32 includes an external slippage surface 322 intended to be in contact with the external slippage path 12, as well as an internal slippage surface 324 intended to be in contact with the internal slippage path 22. The respective centers of curvature C2 and C4 of the surfaces 322 and 324 are shifted relatively to each other, which allows each cam 32 to have an oscillatory movement which allows rotation of the pulley 10 relatively to the hub 20 in the direction of the arrow F1 in FIG. 2 but blocks a reverse movement in the direction of the arrow F2 since the cams then swing into the direction of the arrow F3, which causes jamming and immobilization of both elements 10 and 20 relatively to each other.

According to an aspect, not shown, of the invention, the free wheel 30 may comprise a spring element which it exerts on each cam 32 and an elastic force which tends to bring back this cam into an average position close to being engaged, in an opposite direction of rotation to the arrow F3.

Normally, an amount of lubricant is provided within the free wheel 30 for ensuring smooth operation of the latter, in spite of the repeated swings of the cams 32 around the centers C2 and C4. However it may happen that the lubricant escapes from the inner space of the free wheel 30 or concentrates on the external slippage path 12 notably by a centrifugation effect, causing the slippage path 22 to not being lubricated when operating.

In order to avoid a metal/metal contact between the cams 32 and the hub 20, the slippage path 22 comprises a tungsten disulfide layer 222 which is intended to receive and support the slippage surfaces 324 of the cams 32 according to their pivoting orientation around the center C2 and C4. For the clarity of the drawing, the radial thickness e₂₂₂ of the layer 222 is exaggerated in FIGS. 1 and 2. In practice, this thickness is comprised between 0.5 μm and 0.8 μm. This thickness value is sufficient for the layer 222 to prevent direct metal contact between the elements 20 and 32, while avoiding a too large thickness which would incur the risk of detachment of the layer 222 from the hub 20.

The layer 222 is affixed on the hub 20, for example, by Physical Vapor Deposition or PVD or with a gun, this second method having the advantage of a great simplicity and of lower price cost as a deposition via PVD.

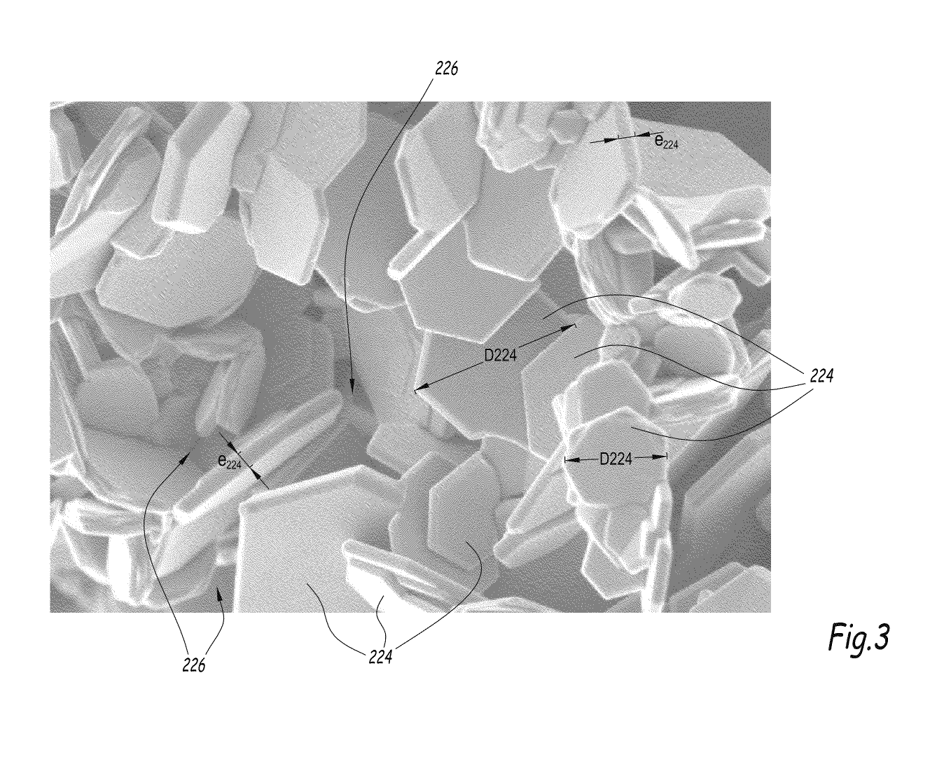

As this more particularly emerges from FIG. 3, the structure of the layer 22 is crystalline and the latter comprises crystals 224 for which the crystalline diameter D224 is comprised between 0.8 and 1.8 μm and for which the thickness e₂₂₄ is less than or equal to 100 nanometers (nm).

Between the crystals 224 visible in FIG. 3, pores 226 are defined in which an amount of lubricant may be confined, such as a grease based on soap of the polyurea or diurea type and an oil of the synthetic hydrocarbon mineral or ester type. In practice this lubricant is found inside the free wheel, between the slippage paths 12 and 22 and the layers 122 and 222 are in contact with this lubricant. Thus, when operating, the layer 222 is impregnated with this lubricant which comes into contact with the surface 324 of each cam 32 when the latter is swung into the direction of the arrow F3.

Alternatively, no lubricant is positioned in the pores 226 and the <<lubrication>> effect between the cams 32 and the hub 20 is only obtained by means of the crystalline structure of tungsten disulfide making up the layer 222, the arrangement of which induces Van Der Waals forces for an anti-slippage function without requiring addition of lubricant.

As the cams 32 are provided for transmitting a significant torque when the free wheel is in a blocked configuration, the contact pressure between the surfaces 324 and the slippage path 22 is a relatively high. Further, the frictional forces when the cams swing into the reverse direction of the arrow F3 in FIG. 2 are also high. It is therefore important to limit direct metal/metal contacts between the cams 32 and the hub 20, as far as possible. This is exactly what may be obtained by the tungsten disulfide layer 222.

According to an optional aspect of the invention, the second slippage path 12 also comprises a tungsten disulfide layer 122 affixed on the internal radial surface 11 of the pulley 10 and intended to receive and support the surfaces 322 of the cams 32.

According to another optional aspect of the invention only illustrated on the left cam of FIG. 2, the surfaces 322 and/or 324 of the cams 32 may also themselves be connected with a tungsten disulfide layer 3222 and/or 3242. This also participates in limiting the frictional processes and the direct metal/metal contacts between the cams 32 and their environment. The layers 3222 and 3242 may also be impregnated with lubricant.

In practice, the thicknesses and the crystalline structures of the layers 122, 3222 and 3242 are similar to those of the layer 222, or smaller.

According to an aspect of the invention which is not illustrated, the slippage paths 12 and 22 may be made on rings respectively positioned inside the pulley 10 and around the hub 20, these rings being secured to this pulley on the one hand and to this hub on the other hand.

The embodiments and alternatives contemplated above may be combined together for generating other embodiments of the invention.

1. A disconnectable pulley device comprising:
a central member;
a pulley mounted around the central member; and
a free wheel itself comprising several cams mounted between a first slippage path, made on an external radial surface of the central member or of an element secured to this member, and a second slippage path, made on an internal radial surface of the pulley or of an element secured to the pulley, the free wheel ensuring a unidirectional clutch between the pulley and the central member,
wherein that at least one slippage path, from among the first and second slippage paths of the free wheel, and/or a portion of the cams intended to interact with either one of the first and second slippage paths of the free wheel comprises a tungsten disulfide layer.

2. The disconnectable pulley device according to claim 1, wherein the first slippage path comprises a tungsten disulfide layer.

3. The disconnectable pulley device according to claim 1, wherein the second slippage path comprises a tungsten disulfide layer.

4. The disconnectable pulley device according to claim 1, wherein portions of the cams intended to interact with either one of the slippage paths are coated with a tungsten disulfide layer.

5. The disconnectable pulley device according to claim 1, wherein each tungsten disulfide layer has a radial thickness comprised between 0.5 μm and 0.8 μm.

6. The disconnectable pulley device according to claim 1, wherein the tungsten disulfide is in a crystalline form, with crystals for which the crystalline diameter is comprised between 0.8 and 1.5 μm and for which the thickness is less than or equal to 100 nm.

7. The disconnectable pulley device according to claim 1, wherein the free wheel comprises a lubricant positioned between the first slippage path and the second slippage path, so as to impregnate each tungsten disulfide layer with the lubricant, notably a grease based on a soap of the polyurea or diurea type and on and on oil the synthetic hydrocarbon mineral or ester type.

8. The disconnectable pulley device according to claim 1, wherein each tungsten disulfide layer fulfills an anti-slippage function without any addition of lubricant.

9. The disconnectable pulley device according to claim 1, wherein the central member is fitted to a shaft of an alternator.

10. The disconnectable pulley device according to claim 1, wherein the central member is fitted to a shaft of an element of an internal combustion engine and a shaft of an accessory fitted to an internal combustion engine.
